(19) United States
(12) Patent Application Publication
(10) Pub. No.: US 2024/0220587 A1
(43) Pub. Date: Jul. 4, 2024

(54) MANAGING PERMISSIONS TO ITEMS OF INVENTORY THAT ARE ORGANIZED IN A HIERARCHY AND ASSIGNED SCALAR VALUES ACCORDING TO THEIR POSITIONS IN THE HIERARCHY

(71) Applicant: VMWARE, INC., Palo Alto, CA (US)

(72) Inventors: SREETAM PARIDA, Bangalore (IN); PRAVEEN TIRUMANYAM, Bangalore (IN); NARASIMHA GOPAL GORTHI, Bangalore (IN); NARASIMHA MURTHI, Bangalore (IN); AVINASH VENKATESH BHAT, Bangalore (IN)

(21) Appl. No.: 18/113,093

(22) Filed: Feb. 23, 2023

(30) Foreign Application Priority Data
Jan. 4, 2023 (IN) 202341000579

(51) Int. Cl. G06F 21/31

(52) U.S. Cl. CPC G06F 21/31

(57) ABSTRACT

Scalar values are assigned to hierarchically-arranged items of inventory of one or more data centers, which may be physical or software-defined, based on the positions of the inventory items in the hierarchy. The scalar values are assigned to the items such that they have increasing values when the items are traversed during a depth-first search of the hierarchy. With this assignment, items of inventory to which a user has access permissions, or any other type of permissions, can be specified as one or more ranges of the scalar values, and such items can be determined from the specified one or more ranges.

### RELATED APPLICATION

Benefit is claimed under 35 U.S.C. 119(a)-(d) to Foreign Application Serial No. 202341000579 filed in India entitled “MANAGING PERMISSIONS TO ITEMS OF INVENTORY THAT ARE ORGANIZED IN A HIERARCHY AND ASSIGNED SCALAR VALUES ACCORDING TO THEIR POSITIONS IN THE HIERARCHY”, on Jan. 4, 2023 by VMware, Inc., which is herein incorporated in its entirety by reference for all purposes.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration between the hosts, distributed power management, dynamic VM placement according to affinity and anti-affinity rules, and high availability (HA). The management software also manages a shared storage device to provision storage resources for the cluster from the shared storage device, and a software-defined network through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

With a large number of SDDCs, managing the full inventory of a customer from a single pane of glass across all of the SDDCs of the customer has proven to be challenging, especially where access to the items in the inventory, which are arranged in a hierarchical manner, are governed by role-based access control. An efficient technique for computing permissions across a large number of inventory items that are organized in a hierarchical manner is described in U.S. patent application Ser. No. 17/901,903, filed Sep. 2, 2022, the entire contents of which are incorporated by reference herein. The technique, however, relies on user access paths and managing permissions that are based on user access paths can be complex and cumbersome in situations where inventory items are organized in a hierarchical manner and permissions to such inventory items are allowed to be set independently for different users and user groups.

### SUMMARY

In one or more embodiments, scalar values are assigned to hierarchically-arranged items of inventory of one or more data centers, which may be physical or software-defined, based on the positions of the inventory items in the hierarchy. The scalar values are assigned to the items such that they have increasing values when the items are traversed during a depth-first search of the hierarchy. With this assignment, items of inventory to which a user has access permissions, or any other type of permissions, can be specified as one or more ranges of the scalar values, and such items can be determined from the specified one or more ranges.

A method of managing permissions to items of inventory of a data center, wherein the items are organized in a hierarchical manner across nodes of a hierarchical tree, includes the steps of: assigning scalar values to the items according to positions of the items in the hierarchical tree; accessing a permissions database to search for permissions to the items granted to the user; generating one or more ranges of the scalar values based on the permissions to the items granted to the user, wherein the one or more ranges of the scalar values are representative of the items of the inventory that the user has permission to access; and displaying on a user interface the items of the inventory that have been assigned the scalar values in the one or more ranges while not displaying on the user interface the items of the inventory that have been assigned the scalar values that are not in the one or more ranges.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a conceptual block diagram of customer environments of different organizations that are managed through a multi-tenant cloud platform.

FIG. 2 illustrates components of the multi-tenant cloud platform and an agent platform appliance that are involved in processing a request from a user to view items of inventory or events that the user is permitted to access.

FIG. 3A illustrates an inventory hierarchy that is defined with respect to clusters.

FIG. 3B illustrates an inventory hierarchy that is defined with respect to folders.

FIG. 4A depicts a hierarchical tree where each node of the hierarchical tree represents an item of inventory in the inventory hierarchy of FIG. 3A.

FIG. 4B depicts the hierarchical tree of FIG. 4A where an item at each node of the hierarchical tree is represented as a scalar value.

FIG. 4C depicts an array of scalar values where each scalar value corresponds to an item of inventory in the inventory hierarchy of FIG. 3A.

FIG. 5A depicts a hierarchical tree where each node of the hierarchical tree represents an item of inventory in the inventory hierarchy of FIG. 3B.

FIG. 5B depicts the hierarchical tree of FIG. 5A where an item at each node of the hierarchical tree is represented as a scalar value.

FIG. 5C depicts an array of scalar values where each scalar value corresponds to an item of inventory in the inventory hierarchy of FIG. 3B.

FIG. 6 is a flow diagram that illustrates a method of assigning a scalar value to items of inventory arranged across nodes of a hierarchical tree.

FIG. 7 is a sample user interface for setting permissions for an item or items of inventory at a particular node of the inventory hierarchy.

FIG. 8A is a sample user interface for setting permissions at a root node of the inventory hierarchy of FIG. 3A.

FIG. 8B is the inventory hierarchy of FIG. 3A that has been filtered according to permissions set with the user interface of FIG. 8A.

FIG. 8C depicts a range of scalar values and corresponding items of inventory that the user may access as a result of the permission set through the user interface of FIG. 8A.

FIG. 9A is a sample user interface for setting permissions at an interim node of the inventory hierarchy of FIG. 3A after the permissions have been set at the root node.

FIG. 9B is the inventory hierarchy of FIG. 3A that has been filtered according to permissions set with the user interface of FIG. 8A and the user interface of FIG. 9A.

FIG. 9C depicts a range of scalar values and corresponding items of inventory that the user may access as a result of the permissions set through the user interface of FIG. 8A and the user interface of FIG. 9A.

FIG. 10A is a sample user interface for setting permissions at a root node of the inventory hierarchy of FIG. 3B.

FIG. 10B is the inventory hierarchy of FIG. 3B that has been filtered according to permissions set with the user interface of FIG. 10A.

FIG. 10C depicts a range of scalar values and corresponding items of inventory that the user may access as a result of the permission set through the user interface of FIG. 10A.

FIG. 11A is a sample user interface for setting permissions at an interim node of the inventory hierarchy of FIG. 3B after the permissions have been set at the root node.

FIG. 11B is the inventory hierarchy of FIG. 3B that has been filtered according to permissions set with the user interface of FIG. 10A and the user interface of FIG. 11A.

FIG. 11C depicts a range of scalar values and corresponding items of inventory that the user may access as a result of the permissions set through the user interface of FIG. 10A and the user interface of FIG. 11A.

FIG. 12 is a flow diagram for a method of generating one or more ranges of scalar values assigned to items of inventory that a user or group has permission to access.

FIG. 13A illustrates changes to the hierarchical tree of FIG. 4A when an item is added to the inventory.

FIG. 13B depicts the hierarchical tree of FIG. 12A where the node corresponding to the added item is represented as a scalar value.

FIG. 13C depicts an array of scalar values where the scalar values includes a scalar value corresponding to the added item.

FIG. 14A illustrates changes to the hierarchical tree of FIG. 4A when an item is deleted from the inventory.

FIG. 14B depicts the hierarchical tree of FIG. 13A where the node corresponding to the deleted item is shown as deleted.

FIG. 14C depicts an array of scalar values where the scalar values excludes the scalar value corresponding to the deleted item.

### DETAILED DESCRIPTION

One or more embodiments provide a technique to manage permissions to items of inventory that are organized in a hierarchy and assigned scalar values according to their positions in the hierarchy. In the embodiments, scalar values are assigned to the items such that they have increasing values when the items are traversed during a depth-first search of the hierarchical tree. With this assignment, items of inventory to which a user has access permissions, or any other type of permissions, can be specified as one or more ranges of the scalar values, and such items can be determined from the specified one or more ranges. For example, if the user has global access permissions to the entire inventory except for a particular subtree, the items of inventory for which the user has access permissions can be determined from one or more ranges of scalar values that span the entire range of the scalar values except for a range of scalar values assigned to the items of the subtree.

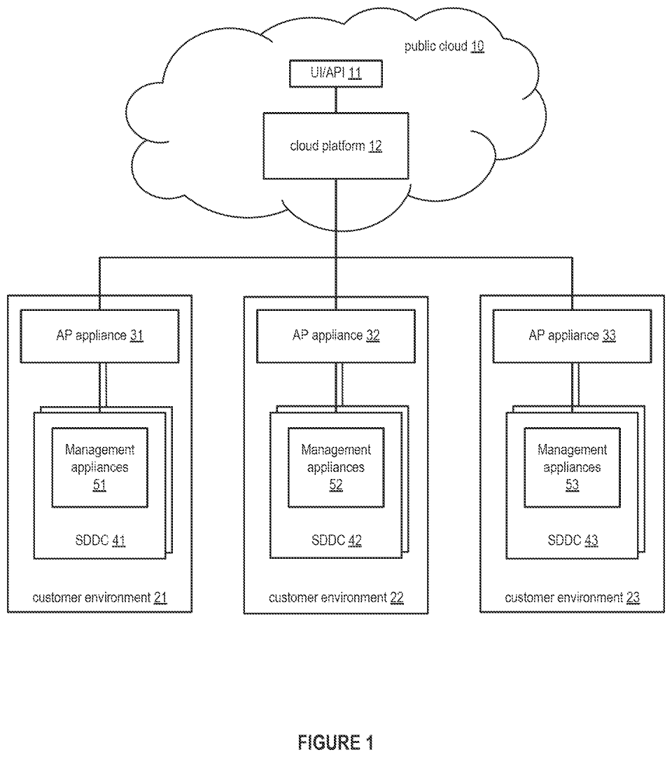

FIG. 1 is a conceptual block diagram of customer environments of different organizations (hereinafter also referred to as “customers” or “tenants”) that are managed through a multi-tenant cloud platform 12, which is implemented in a public cloud 10. A user interface (UI) or an application programming interface (API) of cloud platform 12 is depicted in FIG. 1 as UI/API 11. The computing environment illustrated in FIG. 1 is sometimes referred to as a hybrid cloud environment because it includes a public cloud 10 and a customer environment (e.g., customer environment 21, 22, or 23).

A plurality of SDDCs is depicted in FIG. 1 in each of customer environment 21, customer environment 22, and customer environment 23. In each customer environment, the SDDCs are managed by respective management appliances, which include a virtual infrastructure management (VIM) server appliance (e.g., the VMware vCenter Server® appliance) for overall management of the virtual infrastructure, and a network management server appliance (e.g., the VMware NSX® appliance) for management of the virtual networks. For example, SDDC 41 of the first customer is managed by management appliances 51, SDDC 42 of the second customer by management appliances 52, and SDDC 43 of the third customer by management appliances 53.

The management appliances in each customer environment communicate with an agent platform appliance, which hosts agents that communicate with cloud platform 12 to deliver cloud services to the corresponding customer environment. The communication is over a local area network of the customer environment where the agent platform appliance is deployed. For example, management appliances 51 in customer environment 21 communicate with agent platform appliance 31 over a local area network of customer environment 21. Similarly, management appliances 52 in customer environment 22 communicate with agent platform appliance 32 over a local area network of customer environment 22, and management appliances 53 in customer environment 23 communicate with agent platform appliance 33 over a local area network of customer environment 23.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

In the embodiments, each of the agent platform appliances and the management appliances is a VM instantiated on one or more physical host computers having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, any of the agent platform appliances and the management appliances may be implemented as a physical host computer having the conventional hardware platform described above.

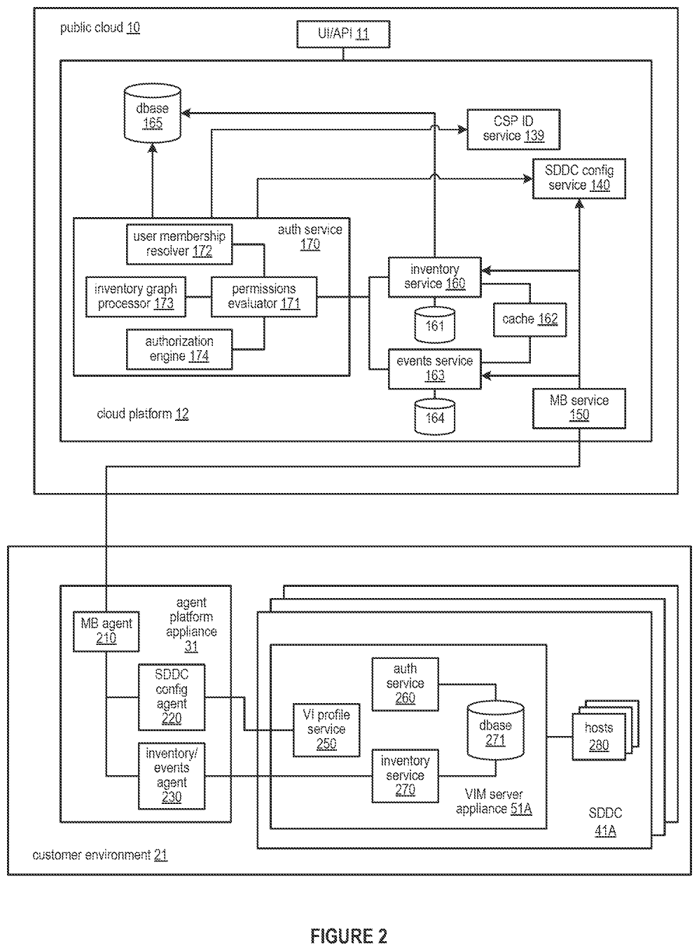

FIG. 2 illustrates components of cloud platform 12 and agent platform appliance 31 that are involved in processing a request from a user to view items of inventory or events that the user is permitted to access. Cloud platform 12 is accessible by different customers through UI/API 11 and each of the different customers manage its full inventory across its group of SDDCs through cloud platform 12. In FIG. 2, the management of the inventory of the SDDCs in customer environment 21, in particular that of SDDC 41A, is selected for illustration. It should be understood that the description given herein for customer environment 21 also apply to other customer environments, including customer environment 22 and customer environment 23.

Cloud platform 12 includes a group of cloud services running in virtual infrastructure of public cloud 10 through which a customer can manage its full inventory across its group of SDDCs by issuing commands through UI/API 11. In the embodiments described herein, each of these cloud services is a microservice that is implemented as one or more container images executed on a virtual infrastructure of public cloud 10.

Cloud services provider (CSP) ID service 139 manages authentication of access to cloud platform 12 through UI/API 11. CSP ID service 139 also maintains group membership information that indicates what users belong to which groups.

SDDC configuration service 140 is responsible for accepting commands made through UI/API 11 and dispatching tasks to a particular customer environment through message broker (MB) service 150 to apply the desired state to the SDDCs. SDDC configuration service 140 is also responsible for processing changes to the desired state reported by the SDDCs, updating the desired state, and dispatching tasks to the SDDCs to apply the updated desired state to the SDDCs.

Inventory service 160 is responsible for tracking items in the full inventory of the SDDCs of each customer, and for each item of inventory, stores identifying information (e.g., name and/or ID), and node information indicating the node of the inventory hierarchy where it is arranged, in inventory database 161. In the embodiments where items of inventory are arranged at nodes of different inventory hierarchies, multiple node information is stored per each item of inventory.

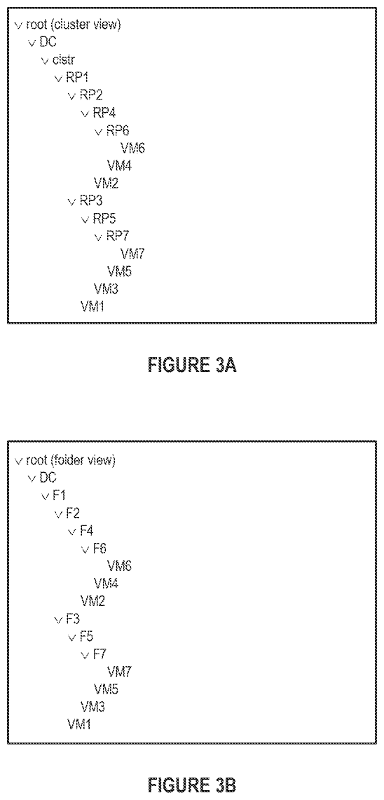

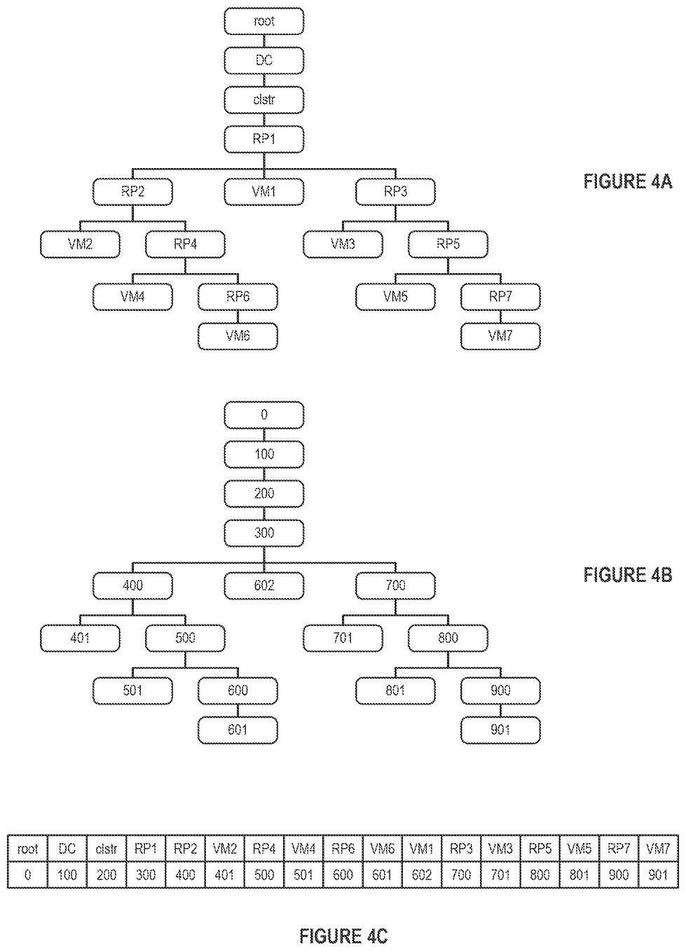

For example, the inventory hierarchy may be defined with respect to clusters as depicted in FIG. 3A and FIG. 4A. In these figures, one cluster (clstr) is depicted as a child node of data center (DC), which has the root node (root) as its parent node. The cluster node has one resource pool RP1, as a child node, and all of the remaining nodes of the inventory hierarchy depicted in FIG. 3A and FIG. 4A are descendent nodes of the resource pool RP1. They include six other resource pools, RP2-RP7, and seven VMs, VM1-VM7.

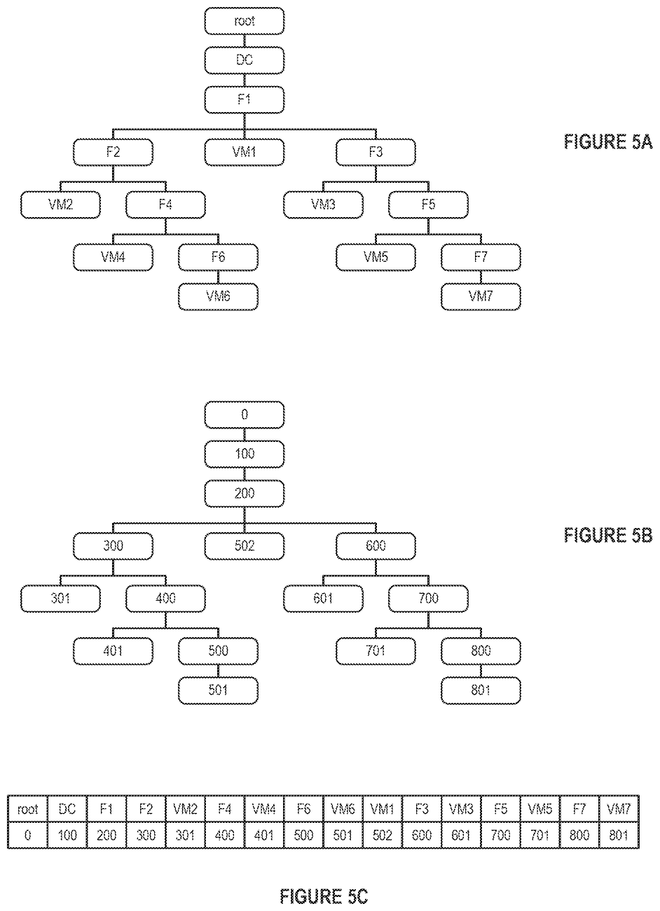

In FIG. 3B and FIG. 5A, the inventory hierarchy is defined with respect to folders. Multiple folders, F1-F7, are depicted in these figures. The folder F1 is the child node of data center (DC), which has the root node (root) as its parent node. All of the remaining nodes of the inventory hierarchy depicted in FIG. 3B and FIG. 5A are descendent nodes of the folder F1. They include six other folders, F2-F7, and seven VMs, VM1-VM7.

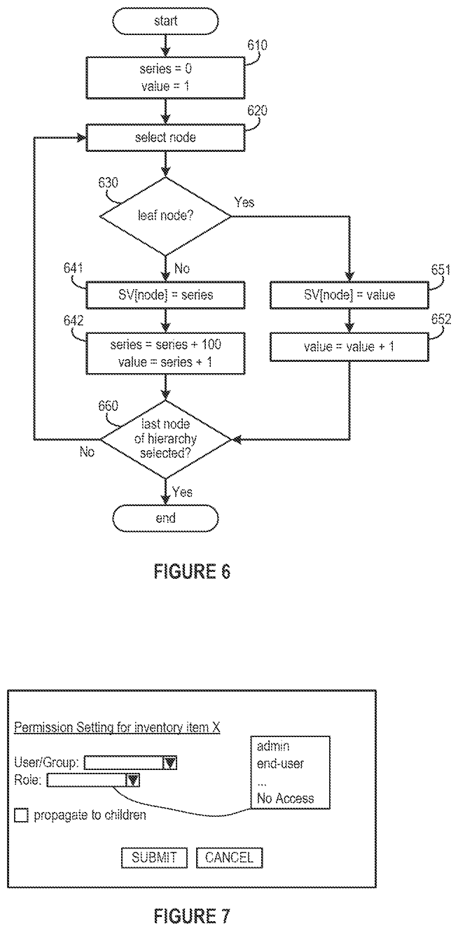

In the embodiments, scalar values are assigned to the items of inventory according to their positions in the inventory hierarchy depicted in FIG. 3A and FIG. 4A or in the inventory hierarchy depicted in FIG. 3B and FIG. 5A, in accordance with the method illustrated in FIG. 6. The method of FIG. 6 is carried out by authorization service 170 (further described below) for each inventory hierarchy, and begins at step 610 where two variables are initialized—the variable ‘series’ is initialized to 0 and the variable ‘value’ is initialized to 1. Then, the method of FIG. 6 executes a loop that begins at step 620 for each node of the inventory hierarchy. In the first loop, the root node of the inventory hierarchy is selected at step 620 and in each of the subsequent loops, the node of the inventory hierarchy that is selected at step 620 is the node that is next in a depth-first traversal of the inventory hierarchy.

The steps of assigning a scalar value to an item at a particular node are different depending on whether or not the node is a leaf node. If the node selected at step 620 is a leaf node as determined by step 630, steps 641 and 642 are executed. At step 641, the scalar value (SV) that is equal to ‘series’ is assigned to the item at the node. Then, at step 642, the variable ‘series’ is incremented by 100 and the variable ‘value’ is set as ‘series’+1. If the node selected at step 620 is not a leaf node as determined by step 630, steps 651 and 652 are executed. At step 651, the scalar value (SV) that is equal to ‘value’ is assigned to the item at the node. Then, at step 652, the variable ‘value’ is incremented by 1. After step 642 or step 652, step 660 is carried out to check if the last node of the inventory hierarchy was selected at step 620. If so, the method ends. If not, the method loops back to step 620, where the node of the inventory hierarchy that is next in the depth-first traversal of the inventory hierarchy is selected.

FIG. 4B depicts the hierarchical tree of FIG. 4A where the item at each node of the hierarchical tree is assigned a scalar value in accordance with the method of FIG. 6. FIG. 4C depicts an array of increasing scalar values where each scalar value corresponds to an item of inventory in the inventory hierarchy of FIG. 3A and FIG. 4A.

FIG. 5B depicts the hierarchical tree of FIG. 5A where the item at each node of the hierarchical tree is assigned a scalar value in accordance with the method of FIG. 6. FIG. 5C depicts an array of increasing scalar values where each scalar value corresponds to an item of inventory in the inventory hierarchy of FIG. 3B and FIG. 5A.

In the embodiments, inventory service 160 tracks permissions that are set locally for each SDDC through a user interface of a VIM server appliance that is managing the inventory of the SDDC. FIG. 7 is a sample user interface for setting permissions for an item or items of inventory at a particular node of either the cluster-view inventory hierarchy (FIG. 3A and FIG. 4A) or the folder-view inventory hierarchy (FIG. 3B and FIG. 5A). A permission for the item of inventory at the particular node is set by selecting a user or a group (which is predefined set of users) against a role (which is a predefined set of one or more privileges). In general, any number of different roles may be predefined and selectable, and in FIG. 7 three different roles are depicted as being selectable. The “admin” role, which grants administrator-level privileges, the “end-user” role, which grants user-level privileges, and the “No Access” role. In the embodiments, all roles except for the “No Access” role include at least a viewing privilege. A “No Access” role is selected when the selected user or group is to be denied any access to the item of inventory at the particular node.

The checkbox for “propagate to children” allows the permission set for an inventory item at any node to be propagated to all child nodes and other nodes, such as grandchildren nodes and leaf nodes, that are descendant nodes. When this checkbox is checked during setting of the permission for the root node of the inventory hierarchy, the resulting permission setting becomes a global permission setting for the entire inventory hierarchy.

The permissions set for each of the SDDCs are reported to inventory service 160 and inventory service 160 stores these permission in a database 165. Each entry of the permissions in database 165 includes the following attributes: identifying information of the inventory hierarchy, node information of the item of inventory for which the permission is created, and the permission (which is defined as a user or group against a particular role).

Events service 163 is responsible for tracking events relating to different items of the full inventory reported by the SDDCs, and for each event, stores identifying information (e.g., name and/or ID), and the item of inventory to which it relates (e.g., name or ID of the item of inventory), in events database 164.

Authorization service 170 includes the following software modules: permission evaluator 171, user membership resolver 172, inventory graph processor 173, and authorization engine 174. Permission evaluator 171 is the endpoint of authorization service 170 that exposes application programming interfaces (APIs) for other services of cloud platform 12 to consume. User membership resolver 172 is responsible for identifying all the groups that the user belongs to by issuing an API to CSP ID service 139, and for acquiring VIM server appliance group information from SDDC configuration service 140. VIM server appliance group information is maintained by SDDC configuration service 140 for each VIM server appliance and indicates what users and groups are permitted access to that VIM server appliance. The permissions are applied at both the individual level and the group level, and so the group information is needed for proper permission evaluation. Inventory graph processor 173 is responsible for constructing an inventory graph for each SDDC that is registered with cloud platform 12. Inventory graph processor 173 updates the inventory graph of any SDDC when it receives reports of inventory topology changes from that SDDC. Authorization engine 174 runs the algorithm for assigning scalar values to the items of the inventory hierarchy and generating one or more ranges of scalar values corresponding to items of the inventory hierarchy for which a particular user or group has permissions. The inventory graph constructed and maintained by inventory graph processor 173 is used when authorization engine 174 traverses the inventory hierarchy during assignment of the scalar values.

MB service 150 is responsible for exchanging messages with message broker (MB) agents deployed in different customer environments upon receiving a request to exchange messages from the MB agents. The communication between MB service 150 and the different MB agents is, for example, over a public network such as the Internet. MB service 150 also routes messages to the cloud services running on cloud platform 12. For example, messages containing changes to the inventory, inventory graph, and permissions are routed to inventory service 160 and messages containing events are routed to events service 163.

Agent platform appliance 31 in customer environment 21 has various agents of cloud services running in cloud platform 12 deployed thereon. In the embodiments described herein, each of the agents and services deployed on the agent platform appliances is a microservice that is implemented as one or more container images executing in the agent platform appliances.

The three agents depicted in FIG. 2 include MB agent 210, SDDC configuration agent 220, and inventory/events agent 230. MB agent 210 periodically polls MB service 150 to exchange messages with MB service 150, i.e., to receive messages from MB service 150 and to transmit to MB service 150 messages that it received from other agents deployed in agent platform appliance 31. If a message received from MB service 150 includes a task to apply the desired state, MB agent 210 routes the message to SDDC configuration agent 220. In the other direction, messages containing changes to the inventory, inventory graph, and permissions, and events that are received from inventory/events agent 230 are transmitted to MB service 150 during the next message exchange with MB service 150.

SDDC configuration agent 220 functions as a communication bridge between SDDC configuration service 140 running on cloud platform 12 and configuration services running in the management appliances of the SDDCs that are deployed in the same customer environment as SDDC configuration agent 220, for example, virtual infrastructure (VI) profile service 250 running in VIM server appliance 51A. When SDDC configuration agent 220 receives a task to apply the desired state, it calls an API of VI profile service 250 to execute the task. In the other direction, VI profile service 250 reports any drift from the desired state to SDDC configuration agent 220 and SDDC configuration agent 220 reports any such drift to SDDC configuration service 140 through MB agent 210 and MB service 150.

Similarly, inventory/events agent 230 functions as a communication bridge between inventory service 160 and events service 163 running on cloud platform 12 and inventory services running in the management appliances of the SDDCs that are deployed in the same customer environment as SDDC configuration agent 220, for example, inventory service 270 running in VIM server appliance 51A. When inventory service 270 detects changes to the inventory, inventory graph, and permissions, or certain events that it has subscribed to (e.g., error events), inventory service 270 transmits such changes/events to inventory/events agent 230, and inventory/events agent 230 reports any such changes/events to inventory service 160 and events service 163 through MB agent 210 and MB service 150.

In FIG. 2, VIM server appliance 51A manages SDDC 41A and the inventory of SDDC 41A, which includes VMs, virtual applications, and resource pools of virtual infrastructure provisioned from a cluster of hosts 280. In addition to VI profile service 250 and inventory service 270 described above, VIM server appliance 51A also has running therein an authorization service 260, which is responsible for updating permissions saved in permissions database 271 when permissions are set for an item of inventory, e.g., through the user interface shown in FIG. 7.

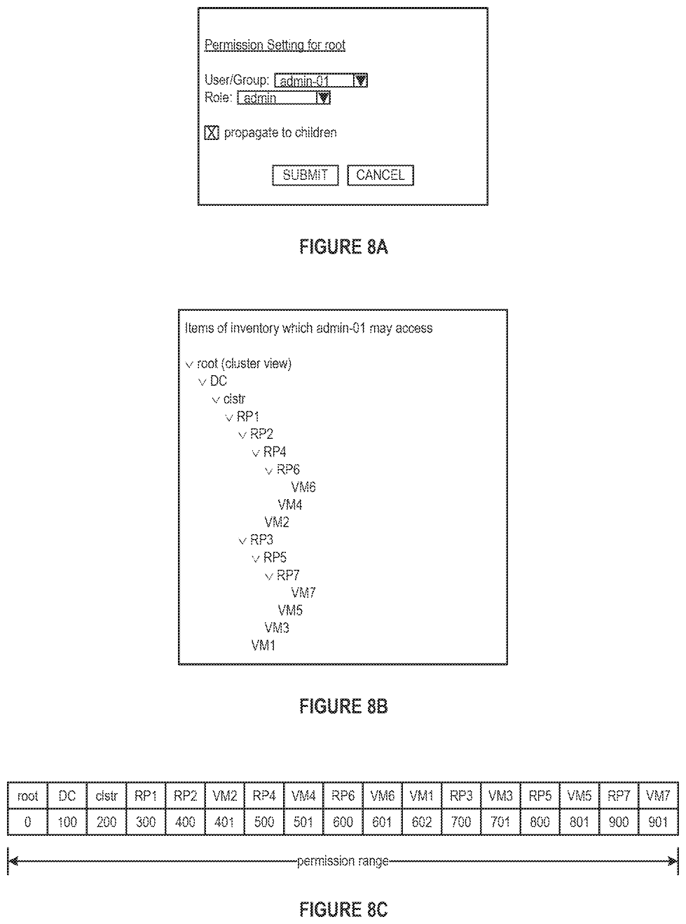

FIG. 8A is a sample user interface for setting permissions. In the example of FIG. 8A, the permission is set at a root node of the inventory hierarchy of FIG. 3A and at all descendent nodes of the root node because the checkbox for “propagate to children” is checked. This permission setting is in essence a global permission setting because the root node and all of its descendent nodes make up all nodes of inventory hierarchy of FIG. 3A. In addition, this permission setting is applicable to the user “admin-01” because the user/group that is selected in the user interface is “admin-01,” and administrative-level privileges are granted to the user “admin-01” because the role that is selected in the user interface is “admin.”

FIG. 8B is the inventory hierarchy of FIG. 3A that has been filtered according to permissions set for the user “admin-01” with the user interface of FIG. 8A. All of the items of inventory hierarchy of FIG. 3A are shown in FIG. 8B because the user “admin-01” has access to all items of the inventory hierarchy of FIG. 3A by virtue of the administrative-level privileges granted to the user “admin-01” through the user interface of FIG. 8A. In the example given herein, the items of inventory to which the user “admin-01” has access permissions as a result of the permission set through the user interface of FIG. 8A can be specified as a single range of scalar values, namely [0, 901]. This range is depicted in FIG. 8C and contains the scalar value 0, the scalar value 901, and all scalar values between 0 and 901.

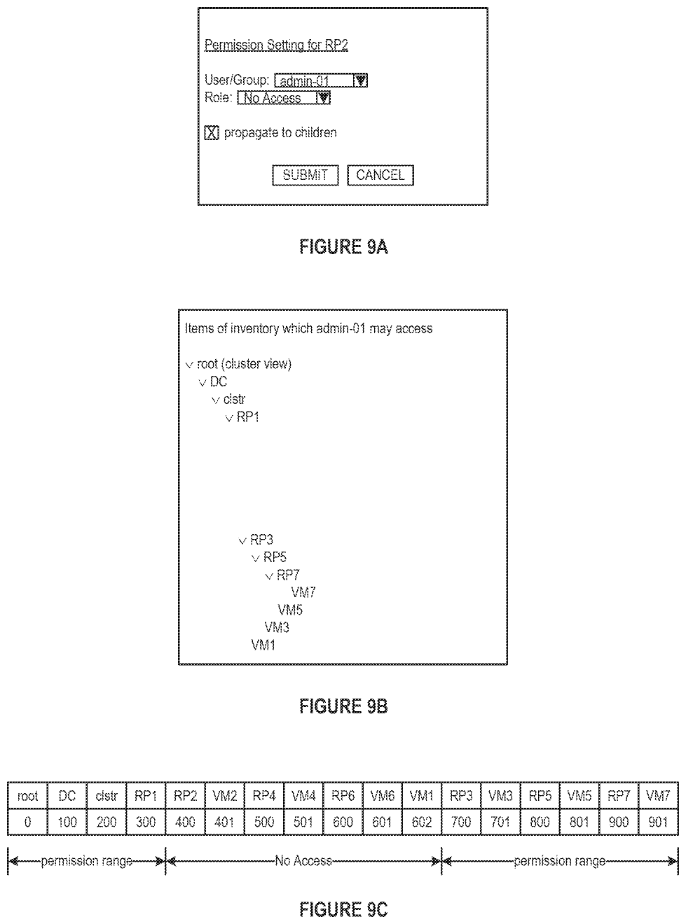

FIG. 9A is another sample user interface for setting permissions. In the example of FIG. 9A, the permission is set at an interim node of the inventory hierarchy of FIG. 3A (for the item RP2) and at all descendent nodes of this interim node because the checkbox for “propagate to children” is checked. This permission setting is applicable to the user “admin-01” because the user/group that is selected in the user interface is “admin-01,” and the user “admin-01” is denied any access to the item RP2 and all items that are arranged at descendent nodes of this interim node because the role that is selected in the user interface is “No Access.”

FIG. 9B is the inventory hierarchy of FIG. 3A that has been filtered according to permissions set for the user “admin-01” with the user interface of FIG. 8A and the user interface of FIG. 9A. All of the items of inventory hierarchy of FIG. 3A are shown in FIG. 8B except for the items to which the user “admin-01” is denied access as a result of the “No Access” role designated through the user interface of FIG. 9A. In the example given herein, the items of inventory to which the user “admin-01” has access permissions as a result of the permissions set through the user interface of FIG. 8A and the user interface of FIG. 9A can be specified as two ranges of scalar values, namely [0, 300] and [700, 901]. These two ranges are depicted in FIG. 9C.

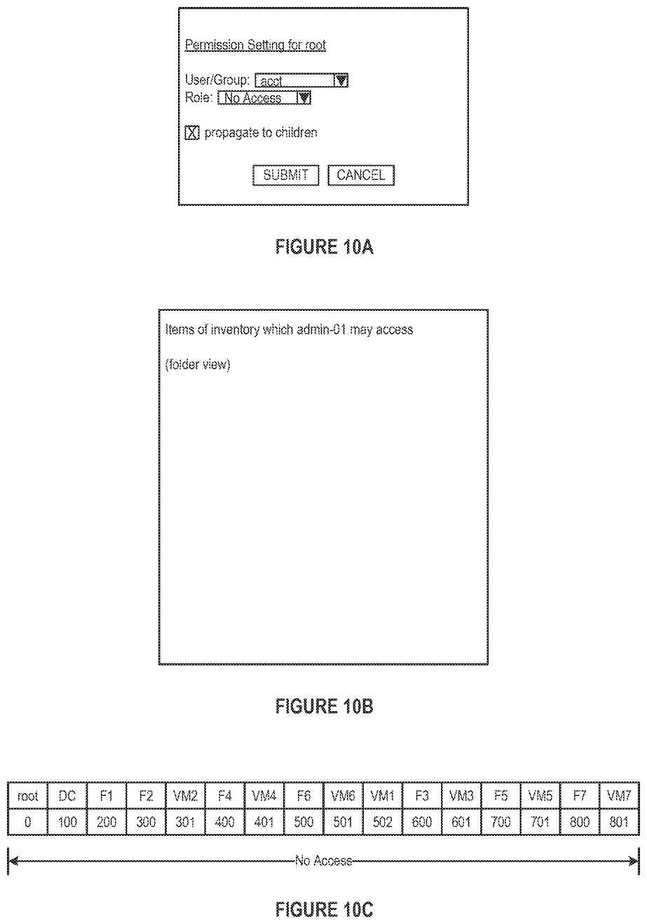

FIG. 10A is another sample user interface for setting permissions. In the example of FIG. 10A, the permission is set at a root node of the inventory hierarchy of FIG. 3B and at all descendent nodes of the root node because the checkbox for “propagate to children” is checked. This permission setting is in essence a global permission setting because the root node and all of its descendent nodes make up all nodes of inventory hierarchy of FIG. 3B. In addition, this permission setting is applicable to the group “acct” (and all users who are members of the group “acct”) because the user/group that is selected in the user interface is “acct,” and no privileges are granted to the group “acct” because the role that is selected in the user interface is “No Access.”

FIG. 10B is the inventory hierarchy of FIG. 3B that has been filtered according to permissions set for the group “acct” with the user interface of FIG. 10A. None of the items of inventory hierarchy of FIG. 3B are shown in FIG. 10B because “No Access” role has been selected for the group “acct” through the user interface of FIG. 10A. In the example given herein, there are no items of inventory to which the group “acct” has access permissions and this range is depicted in FIG. 10C as “No Access.”

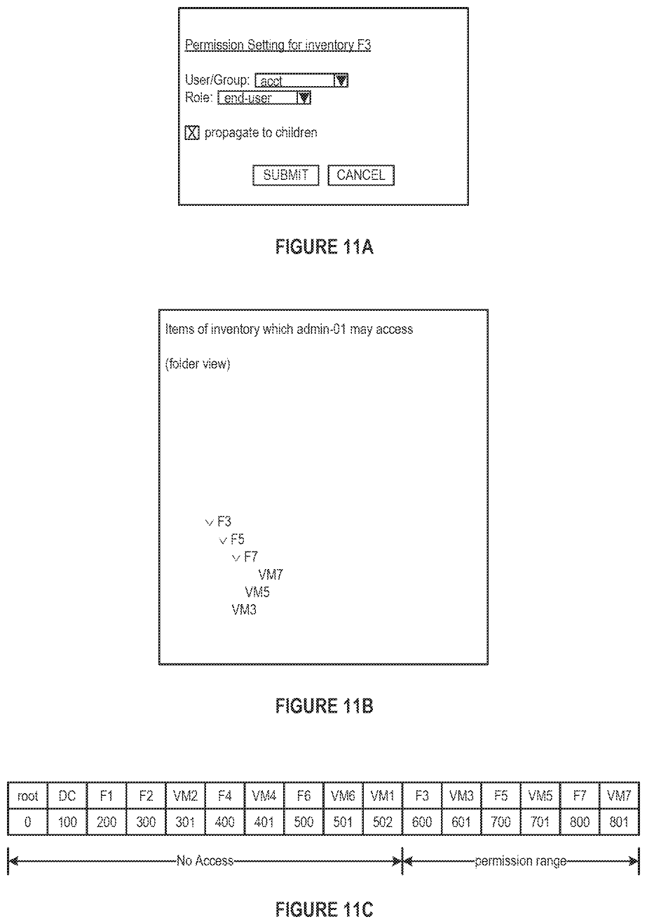

FIG. 11A is another sample user interface for setting permissions. In the example of FIG. 11A, the permission is set at an interim node of the inventory hierarchy of FIG. 3B (for the item F3) and at all descendent nodes of this interim node because the checkbox for “propagate to children” is checked. This permission setting is applicable to the group “acct” because the user/group that is selected in the user interface is “acct,” and user-level privileges are granted to the group “acct” for the item F3 and to all items that are arranged at descendent nodes of this interim node because the role that is selected in the user interface is “end-user.”

FIG. 11B is the inventory hierarchy of FIG. 3B that has been filtered according to permissions set for the group “acct” with the user interface of FIG. 10A and the user interface of FIG. 11A. None of the items of inventory hierarchy of FIG. 3B are shown in FIG. 10B except for the items to which the group “acct” has access by virtue of the user-level privileges granted to the group “acct” through the user interface of FIG. 11A. In the example given herein, the items of inventory to which the group “acct” has access permissions as a result of the permissions set through the user interface of FIG. 10A and the user interface of FIG. 11A can be specified as a single range of scalar values, namely [600, 801].

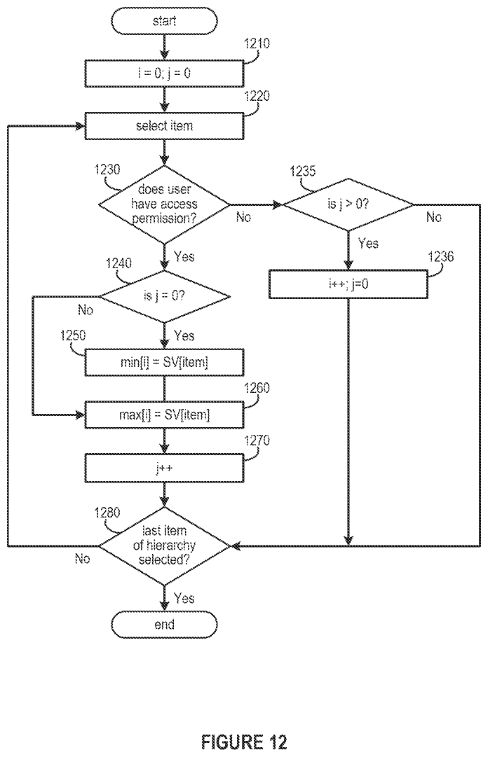

FIG. 12 is a flow diagram for a method of generating one or more ranges of scalar values assigned to items of inventory that a user or group has permission to access. The ranges depicted in FIGS. 8C, 9C, and 11C are generated using this method. The method of FIG. 12 is carried out, for example, by authorization service 170 based on inventory information stored in inventory database 161, permissions information stored in permissions database 165, and inventory graphs generated by inventory graph processor 173.

The method begins with the initialization of two variables, i and j, at step 1210. The variable i is a counter that increments for each different range of scalar values and the variable j is a counter indicating the number of scalar values in a particular range. For example, two different ranges are depicted in FIG. 9C, and the first range is associated with i=0 and contains 4 scalar values (so j=4) and the second range is associated with i=0 and contains 6 scalar values (so j=6). After step 1210, authorization service 170 performs a depth-first search through nodes of the inventory hierarchy using the inventory graph generated by inventory graph processor 173. Step 1220 and subsequent steps up to step 1280 are executed for each item selected as the nodes are traversed.

At step 1230, authorization service 170 refers to permissions database 165 to determine if the user/group has permission to access the item that is selected at step 1220. If so, step 1240 and subsequent steps up to step 1280 are executed until it is determined that the user/group does not have permission to access the item selected at step 1220. Until that happens, the range of scalar values assigned to items the user has permission to access expands with the min value (at step 1250) fixed to be equal to the scalar value of the very first item of the range (e.g., when j is determined to be equal to 0 at step 1240) and the max value (at step 1260) set or updated to be equal to the scalar value of the item selected at step 1220. In addition, the counter for the number of scalar values in the range, which is represented by the variable j, is incremented at step 1270.

If it is determined at step 1280 that the item selected at step 1220 is the last item of the inventory hierarchy, the method ends. Otherwise, the method returns to step 1220 and the next item in the inventory hierarchy is selected.

Returning to step 1230, if the user/group does not have permission to access the item selected at step 1220, step 1235 is executed to determine if j is greater than 0. If so, step 1236 is executed to increment the variable i and to initialize the variable j to 0. After step 1236, and also if j is determined to not be greater than 0 (e.g., j−0) at step 1235, step 1280 described above is executed.

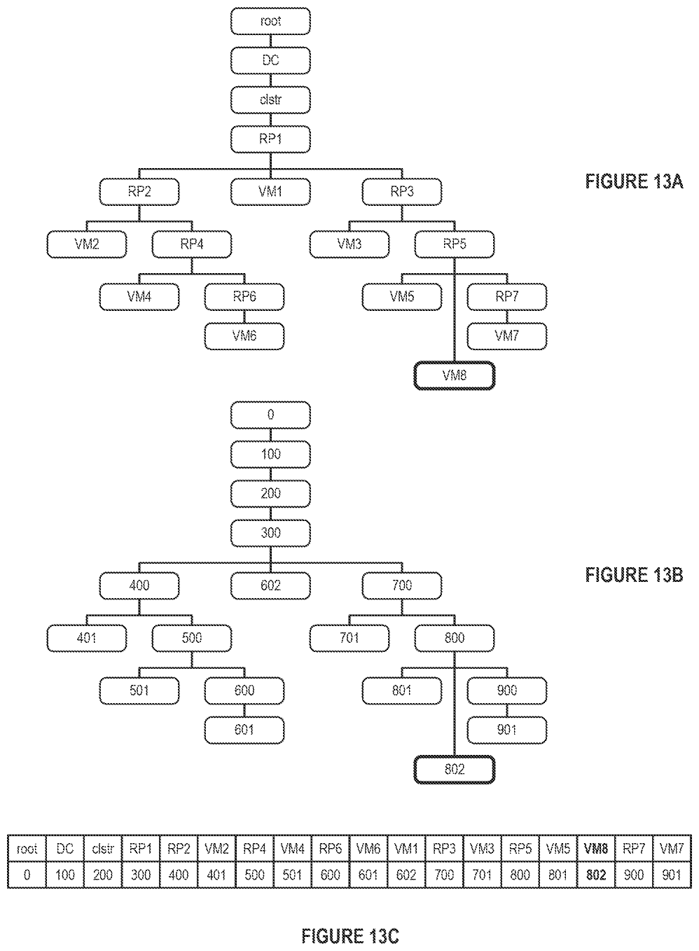

FIG. 13A illustrates changes to the hierarchical tree of FIG. 4A when an item, VM8, is added to the inventory hierarchy. After this change to the inventory hierarchy, authentication service 170 reassigns the scalar values to the items of inventory using the method of FIG. 6. FIG. 13B depicts the hierarchical tree of FIG. 13A where each node of the hierarchical tree, including the added item, is represented as a scalar value. FIG. 13C depicts an array of scalar values where the scalar values includes the scalar value corresponding to the added item.

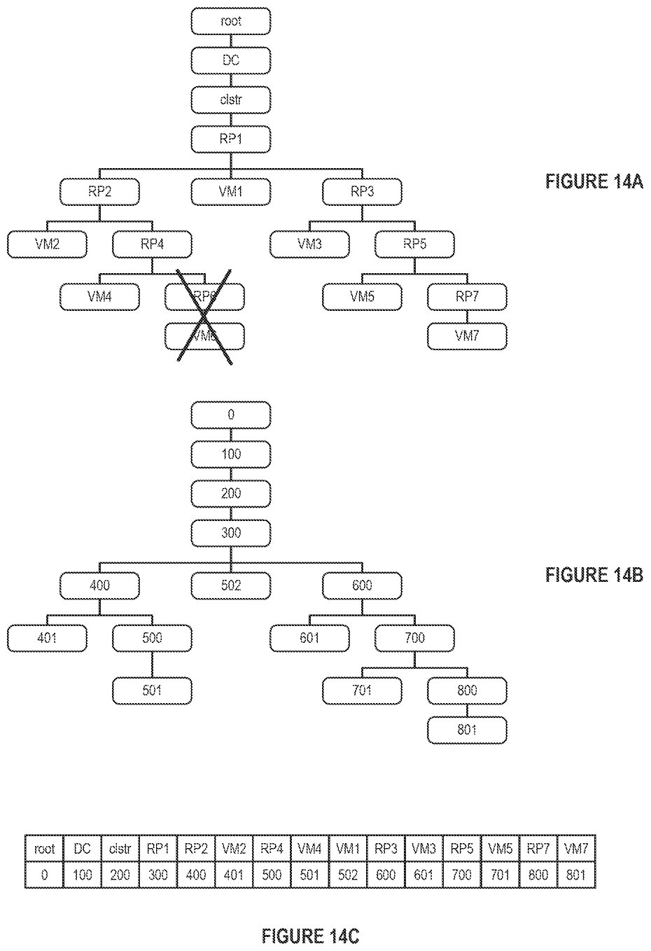

FIG. 14A illustrates changes to the hierarchical tree of FIG. 4A when a subtree is deleted from the inventory hierarchy. After this change to the inventory hierarchy, authentication service 170 reassigns the scalar values to the items of inventory using the method of FIG. 6. FIG. 14B depicts the hierarchical tree of FIG. 14A with the subtree removed and with each remaining node of the hierarchical tree represented as a scalar value. FIG. 14C depicts an array of scalar values that are assigned to the items of inventory which are remaining after deletion of the subtree.

Embodiments are described above in the context of managing permissions of items of inventory from a cloud platform, and thus applicable to the inventory that contains inventory items that may be distributed across different data centers and to which permissions are set in a corresponding one of the data centers. Embodiments, however, are also applicable to an inventory of a single data center, where permissions to items of such inventory are managed through a VIM server appliance that manages configurations and inventory of the single data center. In such embodiments, the authorization service running in the VIM server appliance (e.g., authorization service 260) runs the algorithm for assigning scalar values to the nodes of the inventory hierarchy and generating one or more ranges of scalar values corresponding to items of the inventory hierarchy for which a particular user or group has permissions.

In addition, embodiments are described herein with respect to items of inventory of one or more data centers that are arranged across nodes of a hierarchical tree. However, embodiments are not limited to inventory items of a data center, and may be extended to any collection of items that can be represented in a hierarchical manner where scalar values are assigned to such items according to their position in the hierarchy.

Furthermore, in the examples given above, the scalar values are assigned to items of inventory with respect to access permissions, i.e., whether a particular user or group has permission to access the items of inventory. However, scalar values may be assigned with respect to other types of permissions, e.g., permissions to create or delete an item of inventory. Also, the scalar values are applicable for a particular user or group. A different user or group will have a different set of scalar values assigned to the items of inventory according to the permissions that have been set for such user or group.

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing permissions to items of inventory of a data center, wherein the items are organized in a hierarchical manner across nodes of a hierarchical tree, said method comprising:
assigning scalar values to the items according to positions of the items in the hierarchical tree;
accessing a permissions database to search for permissions to the items granted to the user;
generating one or more ranges of the scalar values based on the permissions to the items granted to the user, wherein the one or more ranges of the scalar values are representative of the items of the inventory that the user has permission to access; and
displaying on a user interface the items of the inventory that have been assigned the scalar values in the one or more ranges while not displaying on the user interface the items of the inventory that have been assigned the scalar values that are not in the one or more ranges.

2. The method of claim 1, wherein the scalar values include a minimum value assigned to an item of the inventory that is at a root node of the hierarchical tree and a maximum value assigned to an item of the inventory that is at a node of the hierarchical tree which is traversed last when a depth-first search of the hierarchical tree is carried out.

3. The method of claim 2, wherein
the scalar values are assigned to the items of the inventory such that each item of the inventory after the root node is assigned a greater scalar value than a preceding item of the inventory as the items of the inventory are traversed during the depth-first search of the hierarchical tree.

4. The method of claim 3, wherein
if the user has permissions to access all of the items of the inventory, the one or more ranges of the scalar values include an entire range of the scalar values.

5. The method of claim 3, wherein
if the user has permissions to access all of the items of the inventory except for a first item of the inventory that is at a first node of the hierarchical tree and one or more other items of the inventory that are at other nodes of the hierarchical tree, which are descendant nodes of the first node,
the one or more ranges of scalar values include a first range of the scalar values and a second range of the scalar values, and exclude a third range of the scalar values, the third range containing scalar values that are greater than each scalar value in the first range and less than each scalar value in the second range, wherein a minimum value of the scalar values in the third range is the scalar value assigned to the first item of the inventory.

6. The method of claim 3, wherein
if the user has no permission to access any of the items of the inventory except for a first item of the inventory that is at a first node of the hierarchical tree and one or more other items of the inventory that are at other nodes of the hierarchical tree, which are descendant nodes of the first node,
the one or more ranges of scalar values include a first range of the scalar values, wherein a minimum value of the scalar values in the first range is the scalar value assigned to the first item of the inventory.

7. The method of claim 1, further comprising:
in response to an update to the inventory, re-assigning scalar values to the items of the updated inventory according to positions of the items of the updated inventory in the hierarchical tree;
re-generating one or more ranges of the scalar values based on the permissions granted to the user; and
displaying on a user interface the items of the updated inventory that have been assigned the scalar values in the one or more re-generated ranges while not displaying on the user interface the items of the updated inventory that have been assigned the scalar values that are not in the one or more re-generated ranges.

8. A non-transitory computer readable medium comprising instructions that are executable on a processor to carry out a method of managing items of inventory of a data center, wherein the items of inventory are organized in a hierarchical manner across nodes of a hierarchical tree, said method comprising:
assigning scalar values to the items according to positions of the items in the hierarchical tree;
accessing a permissions database to search for permissions to the items granted to the user;
generating one or more ranges of the scalar values based on the permissions to the items granted to the user, wherein the one or more ranges of the scalar values are representative of the items of the inventory that the user has permission to access; and
displaying on a user interface the items of the inventory that have been assigned the scalar values in the one or more ranges while not displaying on the user interface the items of the inventory that have been assigned the scalar values that are not in the one or more ranges.

9. The non-transitory computer readable medium of claim 8, wherein the scalar values include a minimum value assigned to an item of the inventory that is at a root node of the hierarchical tree and a maximum value assigned to an item of the inventory that is at a node of the hierarchical tree which is traversed last when a depth-first search of the hierarchical tree is carried out.

10. The non-transitory computer readable medium of claim 9, wherein
the scalar values are assigned to the items of the inventory such that each item of the inventory after the root node is assigned a greater scalar value than a preceding item of the inventory as the items of the inventory are traversed during the depth-first search of the hierarchical tree.

11. The non-transitory computer readable medium of claim 10, wherein
if the user has permissions to access all of the items of the inventory, the one or more ranges of the scalar values include an entire range of the scalar values.

12. The non-transitory computer readable medium of claim 10, wherein
if the user has permissions to access all of the items of the inventory except for a first item of the inventory that is at a first node of the hierarchical tree and one or more other items of the inventory that are at other nodes of the hierarchical tree, which are descendant nodes of the first node,
the one or more ranges of scalar values include a first range of the scalar values and a second range of the scalar values, and exclude a third range of the scalar values, the third range containing scalar values that are greater than each scalar value in the first range and less than each scalar value in the second range, wherein a minimum value of the scalar values in the third range is the scalar value assigned to the first item of the inventory.

13. The non-transitory computer readable medium of claim 10, wherein
if the user has no permission to access any of the items of the inventory except for a first item of the inventory that is at a first node of the hierarchical tree and one or more other items of the inventory that are at other nodes of the hierarchical tree, which are descendant nodes of the first node,
the one or more ranges of scalar values include a first range of the scalar values, wherein a minimum value of the scalar values in the first range is the scalar value assigned to the first item of the inventory.

14. The non-transitory computer readable medium of claim 8, wherein the method further comprises:
in response to an update to the inventory, re-assigning scalar values to the items of the updated inventory according to positions of the items of the updated inventory in the hierarchical tree;
re-generating one or more ranges of the scalar values based on the permissions granted to the user; and
displaying on a user interface the items of the updated inventory that have been assigned the scalar values in the one or more re-generated ranges while not displaying on the user interface the items of the updated inventory that have been assigned the scalar values that are not in the one or more re-generated ranges.

15. A management server configured to manage items of inventory of a data center, wherein the items of inventory are represented in a hierarchical manner across nodes of a hierarchical tree, and the management server includes a processor that is programmed to carry out the steps of:
assigning scalar values to the items according to positions of the items in the hierarchical tree;
accessing a permissions database to search for permissions to the items granted to the user;
generating one or more ranges of the scalar values based on the permissions to the items granted to the user, wherein the one or more ranges of the scalar values are representative of the items of the inventory that the user has permission to access; and
displaying on a user interface the items of the inventory that have been assigned the scalar values in the one or more ranges while not displaying on the user interface the items of the inventory that have been assigned the scalar values that are not in the one or more ranges.

16. The management server of claim 15, wherein the scalar values include a minimum value assigned to an item of the inventory that is at a root node of the hierarchical tree and a maximum value assigned to an item of the inventory that is at a node of the hierarchical tree which is traversed last when a depth-first search of the hierarchical tree is carried out.

17. The management server of claim 16, wherein
the scalar values are assigned to the items of the inventory such that each item of the inventory after the root node is assigned a greater scalar value than a preceding item of the inventory as the items of the inventory are traversed during the depth-first search of the hierarchical tree.

18. The management server of claim 17, wherein
if the user has permissions to access all of the items of the inventory except for a first item of the inventory that is at a first node of the hierarchical tree and one or more other items of the inventory that are at other nodes of the hierarchical tree, which are descendant nodes of the first node,
the one or more ranges of scalar values include a first range of the scalar values and a second range of the scalar values, and exclude a third range of the scalar values, the third range containing scalar values that are greater than each scalar value in the first range and less than each scalar value in the second range, wherein a minimum value of the scalar values in the third range is the scalar value assigned to the first item of the inventory.

19. The management server of claim 17, wherein
if the user has no permission to access any of the items of the inventory except for a first item of the inventory that is at a first node of the hierarchical tree and one or more other items of the inventory that are at other nodes of the hierarchical tree, which are descendant nodes of the first node,
the one or more ranges of scalar values include a first range of the scalar values, wherein a minimum value of the scalar values in the first range is the scalar value assigned to the first item of the inventory.

20. The management server of claim 15, wherein the processor is programmed to carry out the additional steps of:
in response to an update to the inventory, re-assigning scalar values to the items of the updated inventory according to positions of the items of the updated inventory in the hierarchical tree;
re-generating one or more ranges of the scalar values based on the permissions granted to the user; and
displaying on a user interface the items of the updated inventory that have been assigned the scalar values in the one or more re-generated ranges while not displaying on the user interface the items of the updated inventory that have been assigned the scalar values that are not in the one or more re-generated ranges.
